(19) United States
(12) Patent Application Publication
(10) Pub. No.: US 2024/0244001 A1
(43) Pub. Date: Jul. 18, 2024

(54) Scalable Packet Processing

(71) Applicant: Marvell Asia Pte Ltd, Singapore (SG)

(72) Inventor: Pushkar Upadhye, Pune (IN)

(73) Assignee: Marvell Asia Pte Ltd, Singapore (SG)

(21) Appl. No.: 18/406,944

(22) Filed: Jan. 8, 2024

(30) Foreign Application Priority Data
Jan. 13, 2023 (IN) 202341002898

(51) Int. Cl. H04L 45/745; H04L 12/40; H04L 69/22

(52) U.S. Cl. CPC H04L 45/745; H04L 12/40; H04L 69/22

(57) ABSTRACT

The present disclosure describes apparatuses and methods for scalable packet processing. In some aspects, match logic of a scalable packet processor extracts and compares bits from a packet header to determine if the packet matches a context. The match logic may also determine a context index value based on other bits extracted from the header. In response to the match and based on a virtual function associated with the packet, context generation logic of the packet processor obtains a base context value and a context range value from a lookup table. The context generation logic then determines a context identifier for the packet based on the context index value, base context value, and context range value through modular arithmetic. Accordingly, the packet processor can generate context identifiers for packet distribution across contexts without maintaining a table of every context, enabling efficient scaling of the packet processor with less silicon area.

### CROSS REFERENCE TO RELATED APPLICATION

This present disclosure claims priority to Indian Provisional Patent Application Serial No. 202341002898 filed Jan. 13, 2023, the disclosure of which is incorporated by reference herein in its entirety.

### BACKGROUND

Data centers for cloud computing and other services typically include a large number of servers for communicating, storing, and processing vast amounts of data. The servers of a data center are organized into racks of servers and further into rows of server racks. To facilitate data communication among the servers, various switch and routing devices are deployed into the server racks, as well as between the servers and server components for routing data packets throughout these complex systems. As such, packets traversing a network within the data center may travel through multiple layers of switch and routing devices between various stages of communication, storage, and processing.

The servers and processing components of the servers often implement different communication protocols for generating and routing packet traffic between respective packet sources and end points. Each communication protocol may specify a packet structure for the data that is different from or incompatible with those of the other protocols, which introduces complexity and inefficiency in the switch or routing hardware processing the different types of packets. In some cases, the various types of packets are separated onto respective portions of server hardware and data interfaces to facilitate simplified packet routing. In other cases, additional nodes can be added throughout a system to convert packet traffic of one protocol to another and back again to facilitate cross-protocol communication between end points. Separating packets of multiple protocols onto different data paths or adding layers of translational nodes, however, typically leads to an exponential growth in redundant hardware throughout a system as processing and communication capabilities increase. Accordingly, most packet-based processing systems are unable to handle different types of protocol traffic or are limited in size or use cases due to costs and added latencies associated with increasing hardware complexity.

### SUMMARY

This summary is provided to introduce subject matter that is further described in the Detailed Description and Drawings. Accordingly, this Summary should not be considered to describe essential features nor used to limit the scope of the claimed subject matter.

In some aspects, a method for processing packets for distribution over a host bus includes receiving, from an interconnect, a packet comprising a header and a data field, the packet being associated with a virtual function. The method determines that the packet matches a packet format of a context by comparing a first subset of bits of the header to a format match value and determines a context index value based on a second subset of bits extracted from the header. The method includes obtaining a context base value and a context range value from a lookup table based on an identifier of the virtual function and generating a context identifier using the context index value, the context base value, and the context range value. The method then associates the context identifier with the packet and sends the packet with the context identifier over the host bus for distribution to resources of the context.

In other aspects, an integrated circuit includes packet match logic and context generation logic. The packet match logic includes a register configured to receive a header of a packet, a first configurable register to store a first offset value by which a first subset of bits is extracted from the header of the packet, a second configurable register to store a match value, and a comparator configured to generate a match indicator in response to the first subset of bits extracted from the header matching the match value. The packet match logic also includes a third configurable register to store a second offset value by which a second subset of bits are extracted from the header of the packet and index generation logic configured to generate a context index value based on the second subset of bits of the header of the packet.

The context generation logic includes an encoder with inputs operably coupled with an output of the comparator of the packet match logic and an output of at least one other instance of packet match logic. A multiplexor of the context generation logic has an input coupled to an output of the index generation logic and is configured to select the index value based on an output of the encoder. The context generation logic also includes a context table configured to store, in association virtual functions, respective pairs of base context values and context range values and a modular arithmetic circuit configured to obtain, based on a virtual function identifier associated with the packet and from a lookup table, the respective pair of the base context value and the context range value that corresponds to the virtual function of the packet. Based on the context index value, the base context value, and the context range value, the modular arithmetic circuit generates a context identifier for the packet.

In yet other aspects, a system-on-chip (SoC) includes a first interface to an interconnect, a second interface to a host bus, packet match logic, and context generation logic. The packet match logic is configured to receive, from the first interface, a packet comprising a header and a data field, the packet being associated with a virtual function. The packet match logic is configured to determine that the packet matches a packet format of a context by comparing a first subset of bits of the header to a format match value and determine a context index value based on a second subset of bits extracted from the header. The context generation logic is configured to obtain a context base value and a context range value from a lookup table based on an identifier of the virtual function and generate a context identifier using the context index value, the context base value, and the context range value. The context generation circuit may also be configured to associate the context identifier with the packet and send, via the second interface, the packet with the context identifier for distribution to resources (e.g., memory queues) of the context coupled to the host bus.

The details of one or more implementations are set forth in the accompanying drawings and the following description. Other features and advantages will be apparent from the description and drawings and from the claims.

### BRIEF DESCRIPTION OF THE DRAWINGS

The details of one or more implementations of scalable packet processing are set forth in the accompanying figures and the detailed description below. In the figures, the left-most digit of a reference number identifies the figure in which the reference number first appears. The use of the same reference numbers in different instances in the description and the figures indicates like elements:

FIG. 1 illustrates an example operating environment having systems in which aspects of scalable packet processing can be implemented in accordance with one or more aspects;

FIG. 2 illustrates an example system environment in which a scalable packet processor may be implemented in accordance with one or more aspects;

FIG. 3 illustrates an example configuration of a scalable packet processor implemented in accordance with one or more aspects;

FIG. 4 illustrates an example configuration of packet match logic implemented in accordance with one or more aspects;

FIG. 5 illustrates an example configuration of a context generator implemented in accordance with one or more aspects;

FIG. 6 illustrates an example operational flow of a scalable packet processor in accordance with one or more aspects;

FIG. 7 illustrates example packet match logic parameters in the context of various protocol headers;

FIG. 8 depicts an example method for scalable packet processing in accordance with one or more aspects;

FIG. 9 depicts an example method for processing packets for distribution to resources of a context in accordance with one or more aspects;

FIG. 10 depicts an example method for initializing a scalable packet processor in accordance with one or more aspects; and

FIG. 11 illustrates an example System-on-Chip (SoC) environment in which aspects of scalable packet processing may be implemented.

### DETAILED DESCRIPTION

Servers, computers, and computing components often implement different communication protocols for generating and routing packet traffic between respective packet sources and end points. Each of the communication protocols may specify a packet structure that is different from or incompatible with those of the other protocols, which can prevent some switch or routing hardware from managing all the different types of packet traffic of the data network. In some cases, the various types of packets can be separated onto respective portions of server hardware and data interfaces for simplified packet routing. In other cases, additional nodes can be added throughout a system to convert packet traffic of one protocol to another and back again to facilitate cross-protocol communication. Separating packets of multiple protocols onto different data paths or adding layers of translational nodes, however, typically leads to an exponential growth in redundant hardware throughout a system as processing and communication capabilities increase. Accordingly, many packet-based processing systems are unable to handle different types of protocol traffic or are limited in size or use cases due to costs and added latencies associated with increasing hardware complexity.

This disclosure describes apparatuses and techniques for scalable packet processing. In contrast with preceding techniques of handling packet traffic with increasingly complex and costly hardware, the described apparatuses and techniques may provide highly configurable and scalable aspects of packet processing that enable efficient distribution of packet traffic across multiple contexts. Generally, compute resources or central processing unit (CPU) clusters are often formed from multiple nodes of CPUs or cores of CPUs that are connected using a low latency and high bandwidth interconnect, which may be referred to as a fabric. The CPU nodes may communicate over this fabric with other CPU cores or host resources (e.g., memory queues, accelerators) connected to the fabric using a construct called a message, which may range from 64 bytes to 4 gigabytes. These CPU nodes can connect to the fabric via dedicated hardware, which may be implemented as a host bus adapter (HBA).

A host bus adapter may include logic for segmenting messages into packets, buffering packets, arbitration, packet header parsing and address translations for distributing the packets to respective resources of the CPU nodes, such as queues allocated to particular clients or virtual machines (VM) in host memory. In other words, the memory queues or other resources are provisioned as a group for exclusive use of each application, client, or VM running on the CPU node. As described herein, a group of memory and/or other resources that corresponds to the application, client, or VM can be identified by a unique number or label, which may be referred to as a context, context identifier, context label, context tag, or the like. In some implementations, a CPU node or compute resource is configured as a multi-core node, with the ability to have each core of the node configured to process data from a single context or multiple contexts (e.g., multiplex context). This may enable an application, client, or VM to leverage the benefit of scaling performance by running processing packets of the application using multiple cores (e.g., a context per core). In aspects of scalable packet processing, an HBA is configured with a scalable packet processor to support packet distribution across multiple contexts of multiple respective cores efficiently to enable performance scaling without a linear scaling of hardware complexity or cost (e.g., silicon area, power consumption).

In aspects, a scalable packet processor includes packet match logic (match logic) for matching packets to contexts and a context generator to generate and assign context identifiers (e.g., IDs, tags, labels) to the packets for distribution over multiple contexts. Generally, hardware of the scalable packet processor may be configured to distribute or spread the incoming packets over multiple contexts without hard-wired knowledge of header fields of the incoming packets. The match logic includes configurable registers that provide for the ability to tune packet match criteria, as well as enabling the logic to support different or future packet protocols without hardware changes. The design of the match logic is also scalable in terms of supporting different header sizes or applying more complex matching criteria using multiple instances of the match logic. As described herein, the configurable match logic can also be protocol agnostic, allowing for the matching and distribution of packets compliant with any suitable protocol, such as Ethernet, Fibre Channel, InfiniBand, peripheral component interconnect (PCI) express (PCIe), compute express link (CXL), and so forth. Additionally, the scalable packet processor may include a table of base and range context values implemented through modular arithmetic to support a large number of context identifiers without storing discrete or explicit versions of the context identifiers as employed by preceding techniques, which require significant areas of silicon to support storage of each enabled context.

A scalable packet processor may also include programmable hardware for pattern matching and index generation, and context generation for providing context identifiers for packets matched to respective contexts. In implementations, multiple instances of the match logic can be operatively coupled to a context generator. For example, a context generator can be coupled to four instances of the match logic, which can operate independently or be chained together to create a more elaborate matching criteria covering more header bytes of the packet. Generally, the packet header parsing of the match logic is configurable by programming respective registers for index, type, match, offset, and field-width values. The context generator logic can be implemented as common or shared across the multiple instances of the match logic and configured to provide a context identifier or value indexed from a lookup table of base context and context range (e.g., number of contexts) values. In aspects, the lookup table of the context generator can be configured to store, for a given virtual function, a base context value along with the number of contexts. The lookup table can be configured with as many rows as virtual functions (VF's) of a host system and the context generator can implement modular arithmetic to process the context value entries of the table to generate the context identifier for a packet matched to a context.

By so doing, the described aspects for implementing a lookup table with modular arithmetic can optimize storage space reserved for context identifiers by not storing each and every discrete context value in the lookup table. Instead, a size of the table can be reduced because, for a given range of contexts, the lookup table stores a base value and context value range from which identifiers can be generated for all enabled contexts. The context generator further defines an arithmetic computation method for determining context identifiers or labels through the context base value and context range value, which enables the lookup table to scale up with an increased number of contexts without a corresponding (e.g., linear) increase in lookup table storage area. In other words, the design of the processor is scalable in terms of being able to support large numbers of context identifiers or values due to efficient lookup table sizing. Thus, the use of the scalable packet processor enables optimization of silicon area by employing modular arithmetic to generate the context identifiers. Because the lookup table or its storage element (e.g., static random-access memory (SRAM)) does not expand linearly with an increase in the context numbers, VFs, or core counts, the scalable packet processor also consumes less power than circuits of the preceding techniques.

In aspects, a scalable packet processor includes one or more instances of packet match logic and a context generator. The packet match logic can be configured to parse and compare portions of packet headers with match values to determine matches for packets of a context. The match logic may also parse the headers of the packets and manipulate bits of the parsed headers through Boolean operations to generate an index value useful to provide a context identifier for the packet matching the context. Based on an indication of a packet match, the context generator (or generation logic) can access a lookup table of context base and context range value pairs based on a virtual function to which the packet is associated. By including these value pairs, the lookup table may be implemented in less memory area than other types of context routing tables, which include explicit or discrete values for every available context of a system. Using the index value, a context base value, and a context range value, the context generator computes a context identifier for the packet through modular arithmetic, which can be associated with the packet and sent with the packet to enable routing to resources (e.g., a memory queue) of the context. By so doing, the scalable packet processor may route packets of different protocols to respective resources of contexts with reduced hardware cost and less silicon area.

The following discussion describes an operating environment, configurations, techniques that may be employed in the operating environment, and a System-on-Chip (SoC) in which components of the operating environment may be embodied. In the context of the present disclosure, reference is made to the operating environment, techniques, or various components by way of example only.

### Operating Environment

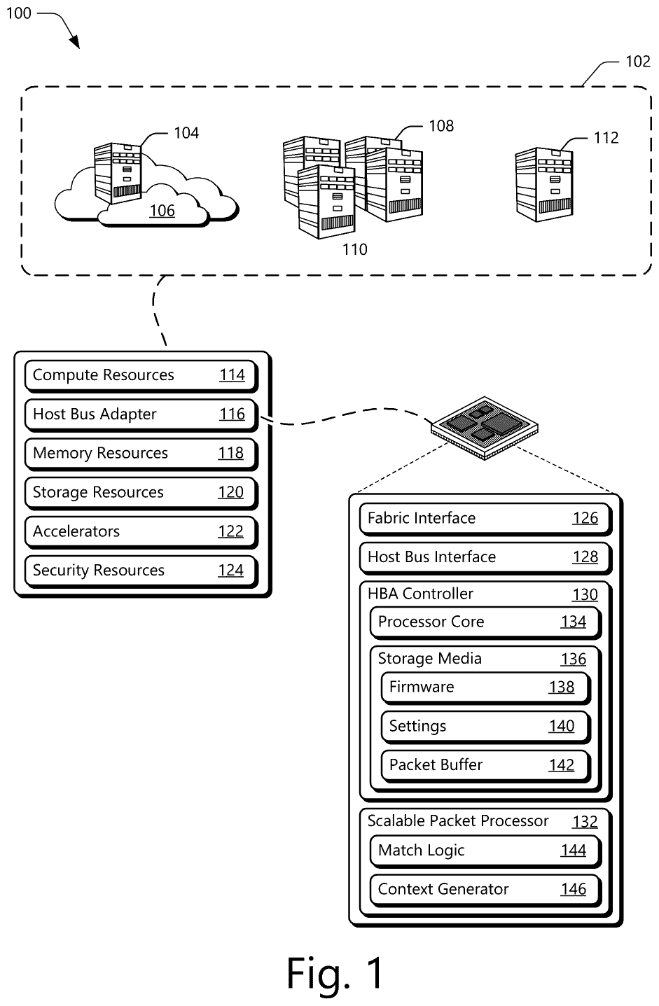

FIG. 1 illustrates an example operating environment 100 having computing systems 102 in which aspects of scalable packet processing may be implemented in accordance with one or more aspects. Generally, a computing system 102 of the operating environment 100 can communicate, store, or process various data, files, objects, or information. Examples of the computing system 102 may include a computing cluster 104 (e.g., of a cloud 106), a server 108 or server hardware of a data center 110, or a server 112 (e.g., standalone), any of which may be configured as part of a data center, server farm, or cloud system. Further examples of a computing system 102 (not shown) may include a network switch, network router, access point, tablet computer, a set-top-box, a data storage appliance, wearable smart-device, television, content-streaming device, high-definition multimedia interface (HDMI) media stick, smart appliance, home automation controller, smart thermostat, Internet-of-Things (IoT) device, mobile-internet device (MID), a network-attached-storage (NAS) drive, server blade, gaming console, automotive entertainment device, automotive computing system, automotive control module (e.g., engine or power train control module), and so on. Generally, the computing system 102 may communicate or store data for any suitable purpose, such as to enable functionalities of various applications (e.g., social media), enable services (e.g., search), store or host data, process data, enable network access, implement gaming platforms, stream media data, provide navigation information, host content creation or editing services, and the like.

In the context of a data center or computing cluster, the computing system 102 may include compute resources 114, a host bus adapter 116, memory resources 118, and storage resources 120. In some cases, the computing system 102 includes accelerators 122 of various types (e.g., encryption hardware, graphics processing) or security resources 124 to protect the computing system 102 and data from malicious actors. Alternatively, a computing system 102 may be operably coupled with a network switch device (e.g., top-of-rack switch), such as when a computing system is coupled to a data network through the network switch device. The compute resources 114 can include any suitable type or number of processors (e.g., x86 or ARM), either single-core or multi-core, for executing instructions or commands of an operating system, firmware, applications, clients, or VMs of the computing system 102.

The memory resources 118 are configured as computer-readable media (CRM) and include memory from which applications, services, virtual machines, tenants, or programs hosted by the computing system 102 are executed or implemented. The memory resources 118 of the computing system 102 may include any suitable type or combination of volatile memory or nonvolatile memory. For example, the memory resources 118 may include various types of random-access memory (RAM), dynamic RAM (DRAM), static RAM (SRAM), read-only memory (ROM), electronically erasable programmable ROM (EEPROM), or Flash memory (e.g., NOR Flash or NAND Flash). The storage resources 120 include non-volatile storage of the computing system 102, such as solid-state drives, optical media, hard disk drives, non-volatile memory express (NVMe) drives, peripheral component interconnect express (PCIe) drives, storage arrays, and so forth. The memory resources 118 and storage resources 120, individually or in combination, may store data associated with the various applications, tenants, workloads, initiators, virtual machines, and/or an operating system of the computing system 102.

In aspects, the computing system 102 includes or is coupled to a data network or fabric by the host bus adapter 116. For example, a server 112 configured to support the execution of multiple applications, clients, or VMs may include a host bus adapter 116 that enables communication between a fabric interconnect (or data network) and components of the server 112, such as the compute resources 114, memory resources 118, storage resources 120, accelerators 122, or security resources 124. Generally, the host bus adapter 116 enables the communication of data packets or messages within the computing system 102 (e.g., between CPU cores, memory queues, accelerators) and/or enables the computing system 102 to communicate data with other computing systems or endpoints (e.g., between racks or rows). In this example, the host bus adapter 116 includes a fabric interface 126 for communicating messages over a fabric interconnect and a host bus interface 128 for communicating packets between components of the computing system. The host bus adapter 116 also includes a host bus adapter controller 130 (HBA controller 130) and a scalable packet processor 132 implemented in accordance with one or more aspects described herein. In other implementations, the host bus adapter or a network interface controller of the computing system may be configured differently, with fewer components or additional components (e.g., hardware accelerators), or with components combined.

As shown in FIG. 1, the HBA controller 130 includes a processor core 134 and storage media 136, which may store or include firmware 138, settings 140, and a packet buffer 142 of the HBA controller 130. The firmware 138 of the HBA controller 130 may include processor-executable instructions executed by the processor core 134 to implement functionalities of the HBA controller 130. Generally, the functionalities implemented by the HBA controller 130 may include segmenting messages into packets, forming packets into messages, buffering packets, arbitration, packet header parsing, and/or address translations for distributing the packets to respective resources of the CPU nodes. The settings 140 may include programming or configuration information for the scalable packet processor 132, which the HBA controller 130 may program at initialization or any time prior to processing packets. In aspects, the packet buffer 142 may receive and store packets while the scalable packet processor generates respective context identifies for the packets. In some implementations, the packet buffer 142 may release packets with associated context identifiers to enable routing of the packets across an interface to resources associated with the context.

The scalable packet processor 132 includes at least one instance of packet match logic 144 (match logic 144) and a context generator 146 (or context logic), which may be operably associated with the HBA controller 130 and/or the packet buffer 142. Generally, the scalable packet processor 132 can be configured to identify and associate respective context identifiers or labels with packets to enable the packets to be distributed over a bus or interconnect to resources (e.g., memory queues) of the context or CPU node. In aspects, the packet match logic 144 is configured for matching packets to respective contexts and generate a context index value, which is useful to generate a context identifier. The context generator 146 can generate and assign context identifiers (e.g., IDs, tags, labels) to the packets for distribution over the multiple contexts. Generally, hardware of the scalable packet processor 132 may be configured to distribute or spread the incoming packets over multiple contexts without hard-wired knowledge of header fields of the incoming packets.

As described herein, the match logic 144 includes configurable registers that provide for the ability to tune packet match criteria, as well as enabling the logic to support different or future packet protocols without hardware changes. The design of the match logic 144 is also scalable in terms of supporting different header sizes or applying more complex matching criteria using multiple instances of the match logic. As such, the configurable match logic can also be protocol agnostic, allowing for the matching and distribution of packets compliant with any suitable protocol, such as Ethernet, Fibre Channel, InfiniBand, peripheral component interconnect express (PCIe), compute express link (CXL), and so forth. In aspects, the context generator 146 is implemented as common or shared logic across the multiple instances of the match logic 144 and configured to provide a context identifier or value indexed from a lookup table of base context and context range (e.g., number of contexts) values. In aspects, the lookup table of the context generator 146 can be configured to store, for a given virtual function, a base context value along with the number of contexts. The lookup table can be configured with as many rows as virtual functions (VF's) of a host system and the context generator 146 can implement modular arithmetic to process the context value entries of the table to generate the context identifier for a packet matched to a context. These are but a few examples of scalable packet processing, others of which are described throughout this disclosure.

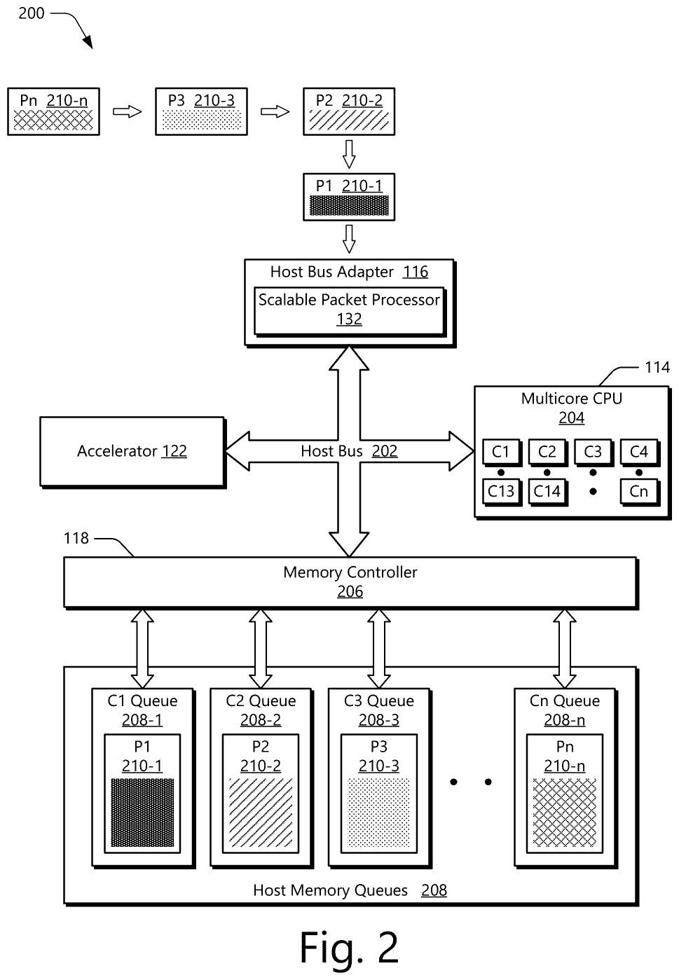

FIG. 2 illustrates at 200 an example system environment in which a scalable packet processor may be implemented in accordance with one or more aspects. In this example, components of a computing system are shown in the context of host bus 202, which couples components of the system that communicate packets over the host bus. As shown in FIG. 2, the host bus 202 couples a multicore CPU 204 or CPU complex of compute resources 114 with a host bus adapter 116, accelerator 122, and a memory controller 206 of memory resources 118. The multicore CPU 204 or CPU complex may include any suitable number of cores, which are illustrated as core 1 (C1), core 2 (C2), through core n (Cn), where n is any suitable integer.

In aspects, administrative or management software can provision individual cores to operate or process data in relation to one or more corresponding contexts. Alternatively or additionally, the management software can provision or configure the memory resources 118 into multiple host memory queues 208, which are assigned to or correspond with contexts or cores of the compute resources 114 or CPU complex. In other words, a core (e.g., core C1) and memory queue (C1 queue) may be provisioned such that the core of the CPU complex is configured to exclusively access data of a corresponding memory queue 208 or other resource associated with a context of the core. In aspects, an application, client, or VM may execute on multiple cores and/or multiple contexts, which enables parallelism and scaling of the application, client, or VM across multiple cores and/or contexts.

Generally, the host bus adapter 116 may receive packets 210 from a data network or fabric for distribution to resources across the host bus 202. In this example, the host bus adapter 116 receives a train of multiple packets 210-1 through 201-n, which can each be assigned or associated with a context of the computing system that corresponds to a CPU core and its resources. As shown by respective patterns, the packet 210-1 is associated with a context of the core C1 and memory queue 208-1, the packet 210-2 is associated with a context of the core C2 and memory queue 208-2, and so forth thorough core Cn and memory queue 208-n of the computing system. In aspects, the scalable packet processor 132 of the host bus adapter 116 can evaluate and label the packets 210 with a context identifier for distribution of the packets over the host bus 202 to a memory queue or other resource that corresponds with the context of the packet.

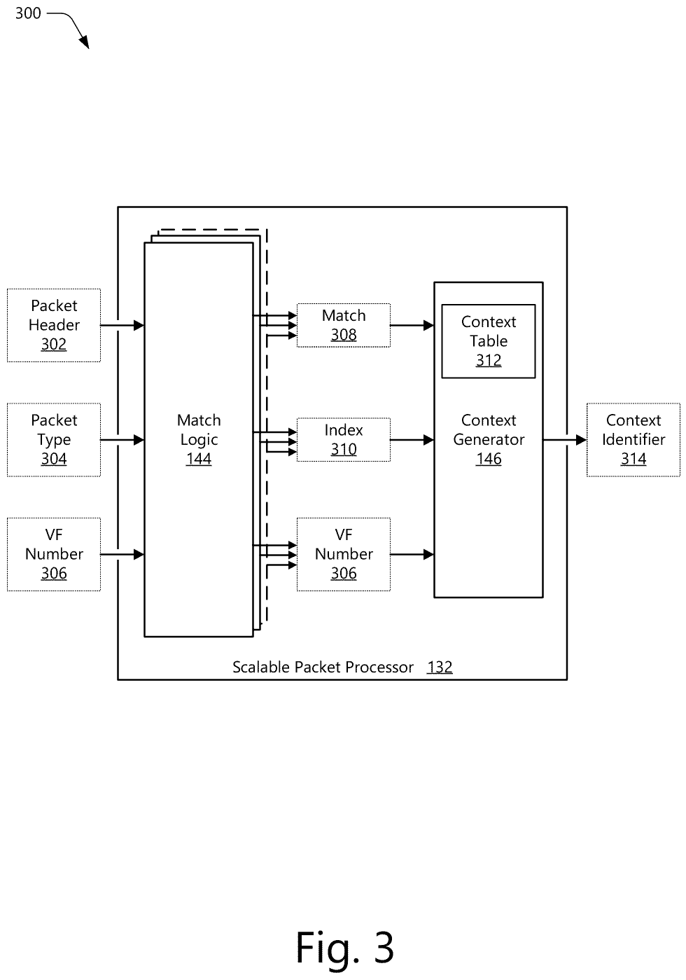

FIG. 3 illustrates at 300 an example configuration of a scalable packet processor implemented in accordance with one or more aspects. In aspects, the scalable packet processor 132 may be implemented using any suitable combination of hardware and software. Thus, the illustrated components of the scalable packet processor 132 can be implemented as a combination of programmable registers and hardware logic configured to implement various aspects of packet processing. In this example, the scalable packet processor 132 includes multiple instances of match logic 144 that are operably coupled with a context generator 146. The scalable packet processor 132, the match logic 144, and/or the context generator 146 may be operably associated with the HBA controller 130 and/or the packet buffer 142.

Generally, the scalable packet processor 132 can be configured to identify and associate respective context identifiers or labels with packets to enable distribution of the packets over a bus or interconnect to resources (e.g., memory queues) of the context or CPU node. In this example, the match logic 144 is configured to receive a packet header 302, an indication of packet type 304, and an indication of a virtual function number 306 with which the packet is associated. In some implementations, the HBA controller 130 or another component of a communication transceiver provides the packet type 304 and/or VF number 306 to the match logic 144. When the match logic 144 receives the packet header 302 and other packet information, the HBA controller 130 may store the associated packet in the packet buffer 142 of the host bus adapter 116. Based on the packet header 302, the packet type 304, and/or the VF number 306, the match logic 144 provides an indication of a packet match 308 and a context index value 310. The match logic 144 may also pass the VF number 306 to the context generator 146, along with the match indicator 308 and the index value 310.

In aspects, the context generator 146 receives, via multiplexor inputs, match indicators 308, index values 310, and VF numbers 306 from the multiple instances of the match logic 144. For a given packet, however, not all instances of the match logic 144 may indicate a packet to context match based on the respective configurations of the match logic registers. Based on a match indication 308, the context generator 146 can use a context table 312, which may include a lookup table, to compute a context identifier 314 for a packet matched to the context. The context table 312, which may be implemented as a lookup table, can be configured to store a base context value along with the number of contexts for each virtual function enabled in the system. In other words, the context table 312 can include as many rows as virtual functions (VF's) of a host system, with a row including a pair of base context and context range values for each instance of the match logic 144. In aspects, the context generator 146 may select context value entries from the context table 312 based on the VF number 306 and which instance of the match logic 144 provides a packet match indication. Based on the selected context base value and context range value, the context generator 146 can implement modular arithmetic to process the context value entries of the context table 312 along with the index value 310 to generate the context identifier for the packet matched to a context.

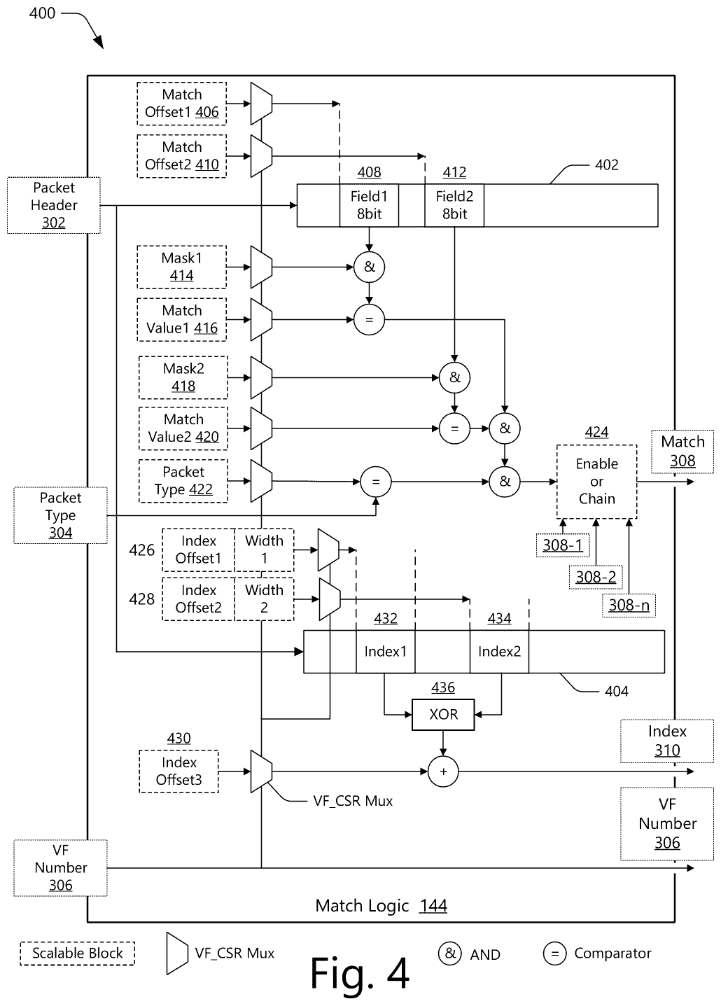

FIG. 4 illustrates at 400 an example configuration of packet match logic implemented in accordance with one or more aspects. Generally, the packet match logic 144 of the scalable packet processor 132 includes programmable hardware for pattern matching of packet headers and index generation for the packets. In aspects, an instance of the packet match logic 144 can be configured to match, based on a header, a packet to a context, which can be mapped to one CPU core of a multicore node and its associated resources, such as a memory queue or accelerator (e.g., video accelerator, audio accelerator, cryptography accelerator, etc.). In some cases, additional instances of the packet match logic 144 are added to support more types of packets or more complex match criteria (e.g., more than two fields extracted from a header). The configuration state registers (CSRs) or configuration registers of the packet match logic 144 may scale linearly with a number of virtual functions or to support a number of VF numbers 306. Thus, the VF number 306 may enable or operate the circuitry, such as the CSR multiplexors (muxes) and Boolean logic (comparators, AND gates), of the match logic 144 when a VF associated with the packet matches a VF for which the match logic is configured to operate. In the context of FIG. 4, scalable elements of the packet match logic 144 are shown with dashed outlines.

In this example, the match logic 144 includes configuration state registers (CSRs) that are programmable to extract two eight-bit fields from a packet header for packet matching and two bit fields from the packet header for index generation, though other configurations of the match logic may extract fewer or additional respective bit fields for these functions. As shown in FIG. 4, the match logic 144 includes a register 402 configured to store a copy of the packet header 302 for pattern matching and a register 440 configure to store another copy of the packet header 302 for index generation. Generally, the header registers may be configured to store any suitable size packet header (e.g., 256 bits to 1024 bits), and various offset values of the match logic 144 may be configured to enable ranging or extraction throughout the header field (e.g., zero to 1024-bit offsets). In some implementations, the pattern matching portion of the match logic 144 includes a first match offset configurable state register 406 (match offset1 CSR 406) configured to store a first offset value for extracting a first bit field 408 (or subset of bits) from the packet header 302 and a second match offset CSR 410 configured to store a second offset value for extracting a second bit field 412 (or subset of bits) from the packet header.

The bit fields or subsets of bits extracted from the packet header for pattern matching may be any suitable size, which may range from four bits to over 32 bits. The match logic 144 may also include a first mask value CSR 414, which can be applied to the first bit field to provide a masked bit field, which is then compared with a match value programmed to a match value CSR 416. Alternatively or additionally, match logic 144 may include a second mask value CSR 418, which can be applied to the second bit field to provide a second masked bit field, which is compared with a second match value programmed to a second match value CSR 420. In aspects, the pattern match logic can be implemented with a packet type CSR 422, which can be programmed with a specific type of packet for comparison with the packet type 304 of the packet.

To determine a packet or pattern match, respective outputs of the match value comparisons and/or the output of the packet type comparison can be combined and provided to enable/chain logic 424 of the match logic 144, along with respective pattern match outputs from other instances of match logic 144. The enable/chain logic 424 can be configured to enable context generation for a matched packet header and/or enable chaining of the outputs from the multiple instances of the pattern match logic. For example, when multiple instances of match logic 144 are configured for complex pattern matching (e.g., more than two eight-bit fields, deeper packet inspection), two or more instances of the match logic 144 may be chained to output a match indication 308 when the match logic 144 determines a pattern or packet match based on the multiple header fields.

In aspects, the match logic 144 includes multiple index offset CSRs 426, 428, and 430 for index generation in this example, though fewer or additional index CSRs may be employed for index generation. A first index offset CSR 426 can be configured with an index offset value, as well as a field-width value by which the match logic 144 extracts a first index bit field 432 or subset of bits from the packet header 302. A second index offset CSR 428 can be configured with a second index offset value, as well as a second field-width value by which the match logic 144 extracts a second index bit field 434 from the packet header 302. The index fields extracted from the packet header 302 may include any suitable number of bits (e.g., two to 32 bits), which may be configured through respective width settings of the CSRs or circuitry of the match logic 144. In aspects, the index generation circuit include Boolean logic 436, here an XOR function, to enable Boolean manipulation of the extracted index fields 432, 434, before another index offset value is optionally applied from another index offset CSR 430 to provide an index value 310 (e.g., eight to 32 bits) for the context generator 146. As shown in FIG. 4, the match logic 144 may also pass the VF number 306 to the context generator 146, though another instance or indication of the VF number 306 may be provided separately.

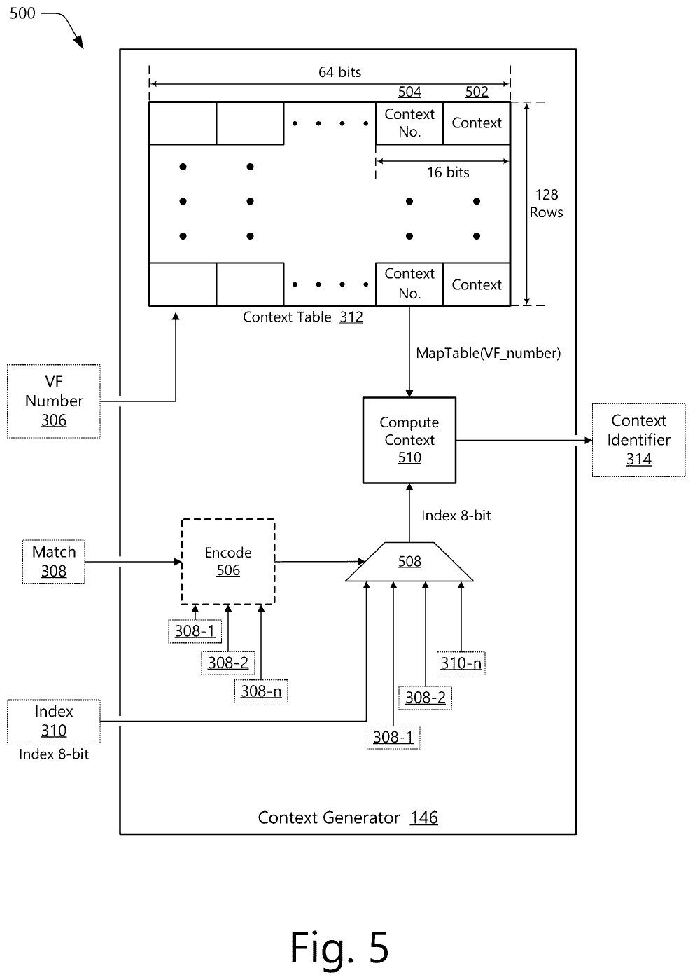

FIG. 5 illustrates at 500 an example configuration of a context generator implemented in accordance with one or more aspects. Generally, the context generator 146 may be implemented with a context table 312 (e.g., a lookup table) and associated logic for accessing the context table and generating context identifiers or context labels for packets through modular arithmetic. In aspects, the context table 312, which may be implemented as a lookup table, can be configured to store a base context value 502 along with the number of contexts 504 (or context range value) for each virtual function enabled in the system. In other words, the context table 312 can include as many rows as virtual functions (VF's) of a host system, with a row including a pair of base context 502 and context range 504 values for each instance of the match logic 144. In this example, a base context value 502 may include eight bits, the context range value may include 8 bits, and the context table may include 64 bits per row to store four 16 bit pairs of the values. Thus, a depth of the context table 312 of the scalable packet processor 132 can be increased to support multiple virtual functions, where each 16-bit table entry of base context (0-256) and number of contexts (0-256) can support up to 256 contexts.

As shown in FIG. 5, the context generator 146 can include index encoding logic 506, index multiplexing logic 508, and context computing logic 510, which may be implemented using any suitable type or combination of registers and logic. The encode logic 506 may receive packet match indications 308 from multiple instances of packet match logic 144, which may include any suitable number of respective 1-bit indications of a packet match from the match logic. An output of the index encode logic 506 may be coupled to an input of the index multiplexing logic 508 to enable selection of one of the index values 310 from the one or more instances of the packet match circuit. Generally, based on an indication of a pattern or packet match, the index multiplexing logic 508 can select a corresponding index value 310 from the match logic and provide the index value to the context computing logic 510.

In aspects, the context generator 146 may select context value entries from the context table 312 based on the VF number 306 and the index value from which instance of the match logic 144 provides a packet match indication. In other words, each row of the context table 312 may include four pairs of 16-bit entries (number of contexts, base context number), which is the number of context enabled for a CPU core and/or resources, and the starting value of the context. The four pairs of values in each row can map to four instances of the match logic 144, and each instance can generate a single-bit match indication 308, which can be encoded to select one of the four pairs of context values. Based on the selected context base value and context range value pair, the context generator 146 can implement modular arithmetic to process the context value entries of the context table 312 along with the index value 310 to generate the context identifier for the packet matched to a context as shown below in Equation 1.

$$Context Identifier = ( Context Base Value + Index ) Mod ( Context Range )$$

### Equation 1: Modular Arithmetic Context Generation

As noted, the context identifier may correspond to a context or tag useful to route the packet to resources of a context, the context base value may represent a starting context value from the context table 312, context range can be a number of contexts enabled. As described herein, the modular arithmetic employed by the scalable packet processor enables optimization of silicon area by generating or computing context identifiers without storing discrete or explicit tables of the contexts. Because the lookup table or its storage element (e.g., static random-access memory (SRAM)) does not expand linearly with an increase in the context numbers, VFs, or core counts, the scalable packet processor also consumes less power than preceding circuits.

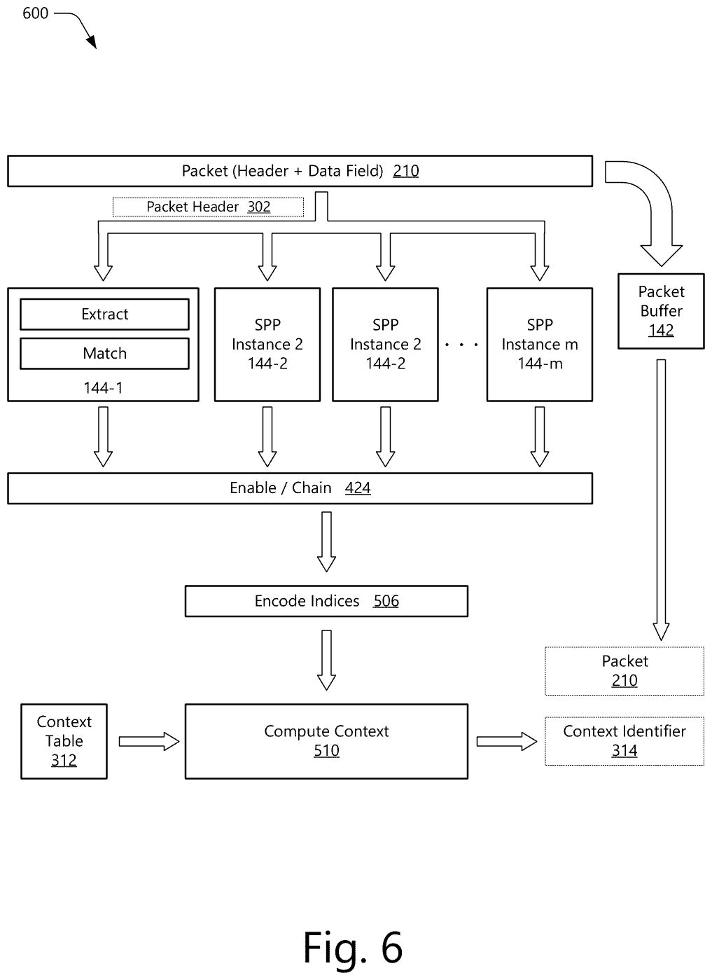

FIG. 6 illustrates at 600 an example operational flow of a scalable packet processor in accordance with one or more aspects. In aspects, a scalable packet processor may include multiple instances of match logic 144 configured to identify and/or match different types of packet or perform deep packet inspection by matching several packet header fields to respective match values. Generally, a packet header 302 is provided to the instances of the match logic 144 and the packet is stored to the packet buffer 142 while the scalable packet processor 132 performs pattern matching and context generation. The multiple instances of the match logic 144 may then extract and compare bit fields or subsets of bits from the packet header, for comparison against respective match values programmed to each instance of the match logic. The match logic 144-1 through 144-n provides match indications to the enable/chain logic 424, which in turn provides match indications and index values to the index encoding logic 506 of the context generator. Based on values obtained from the context table 312 and the index value from the index encoding logic, the context computation logic 510 of the context generator 146 determines a context identifier 314 for the packet 210. In aspects, the scalable packet processor 132 associates the context identifier 314 with the packet 210 and provides the packet 210 with the context identifier 314 to a bus or components for distribution to resources of the context (e.g., memory queue).

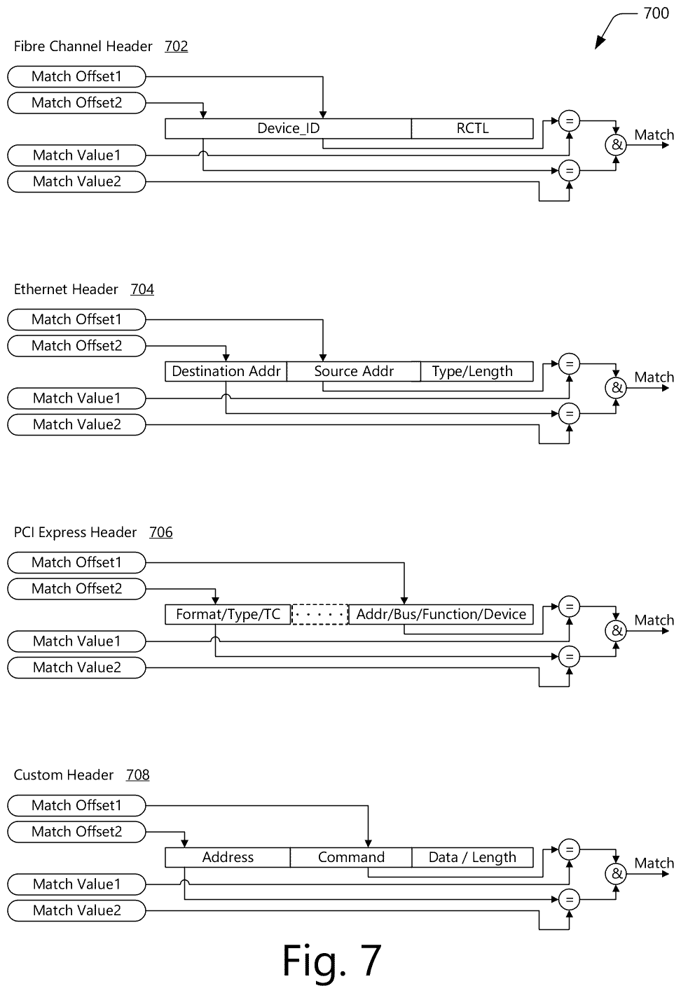

FIG. 7 illustrates at 700 example packet match logic parameters in the context of various protocol headers. As described herein, the offset and match value CSRs of packet match logic may be programmed to implement pattern matching for any suitable type of packet or protocol format. In this example, respective match offset and match values are shown in the context of headers of various packet protocols, which include a Fibre Channel header 702, an Ethernet header 704, a PCIe header 706, and a custom header 708. Generally, the CSRs of an instance of packet match logic 144 may be configured to implement bit field extraction and matching operations to identify and indicate matches for packets with a context, which may be formatted in compliance with any standard or custom protocol.

In this example, at 702, the match offsets of the match logic are configured to extract bit fields or subset of bits from the device identifier field of a Fibre Channel header. The match logic may then compare the bit fields extracted from the Fibre Channel header with corresponding match values to match a Fibre Channel packet to a context assigned to a CPU core or VM of a host. At 704, the match offsets of the match logic are configured to extract respective bit fields from a source address and a destination address of the Ethernet packet, which may then be compared to the match values to determine if the Ethernet packet matches a specific context. At 706, the match offsets of the match logic are configured to extract bit fields or subset of bits from a format/type/traffic class field and an address/bus/function/device field of the PCIe header. The match logic may then compare the bit fields extracted from the PCIe header with corresponding match values to match a PCIe packet to a context assigned to a CPU core or VM of a host. At 708, the match offsets of the match logic are configured to extract respective bit fields from an address field and a command field of a custom packet header, which may then be compared to the match values to determine if the custom packet matches a specific context.

### Techniques for Scalable Packet Processing

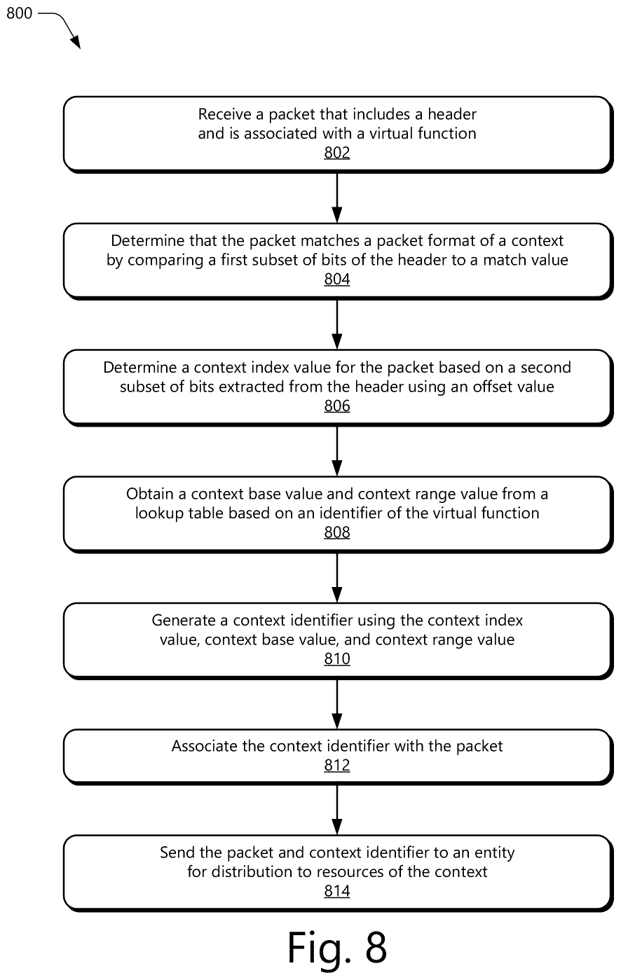

The following discussion describes techniques for scalable packet processing in accordance with one or more aspects. These techniques may be implemented using any of the environments and entities described herein, such as the scalable packet processor 132, settings 140, packet buffer 142, match logic 144, and/or context generator 146. These techniques include various methods illustrated in FIGS. 8-10, each of which is shown as a set of operations that may be performed by one or more entities.

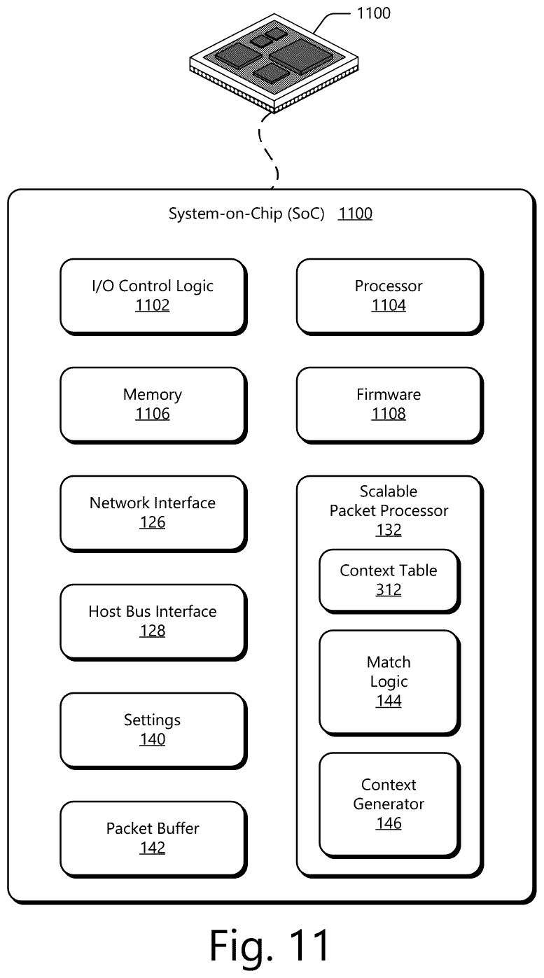

These methods are not necessarily limited to the orders of operations shown in the associated figures. Rather, any of the operations may be repeated, skipped, substituted, or re-ordered to implement various aspects described herein. Further, these methods may be used in conjunction with one another, in whole or in part, whether performed by the same entity, separate entities, or any combination thereof. For example, the methods may be combined to implement packet processing in which multiple instances of packet match logic parse and compare portions of packet headers with match value to determine matches for packets of a context. The match logic may also parse the headers of the packets and manipulate bits of the parsed headers through Boolean operations to generate an index value useful to a generate context identifier for the packet. Based on an indication of a packet match, the context generator (or generation logic) can access a lookup table of context base and context range value pairs based on a virtual function to which the packet is associated. By including these value pairs, the lookup table may be implemented in less memory area than other types of context routing tables, which include explicit or discrete values for every available context of a system. Based on the index value, a context base value, and a context range value, the context generator computes a context identifier for the packet, which can be associated with the packet and sent with the packet to enable routing of the packet to resources (e.g., a memory queue) of the context. By so doing, the aspects of packet processing may route packets of different protocols to respective resources of contexts with reduced hardware cost and less silicon area. In portions of the following discussion, reference will be made to the operating environment 100 of FIG. 1 and various entities or configurations of FIGS. 2-7 by way of example. Such reference is not to be taken as limiting described aspects to the operating environment 100, entities, or configurations, but rather as illustrative of one of a variety of examples. Alternately or additionally, operations of the methods may also be implemented by or with entities described with reference to the SoC of FIG. 11.

FIG. 8 depicts an example method 800 for scalable packet processing in accordance with one or more aspects. The operations of the method 800 may be implemented by a scalable packet processor 132, match logic 144, and/or context generator 146.

At 802, a scalable packet processor receives a packet that includes a header and is associated with a virtual function. The packet may be formatted in compliance with any suitable packet format, such that the header of the packet is structured with predefined bit fields. In some cases, the packet is received via a data network or fabric to which a host bus adapter is operably coupled. Alternatively or additionally, the packet may be received by a communication transceiver configured to communicate in a protocol by which the packet is formatted.

At 804, match logic of the scalable packet processor determines that the packet matches a packet format of a context by comparing a first subset of bits of the header to a match value. In some cases, match logic of the scalable packet processor extracts the first subset of bits from the header based on an offset value and/or masks the first subset of bits to provide a masked subset of bits, which may be compared with the match value to determine that the packet matches a context. Alternatively or additionally, a type of the header may be compared with a type value to determine whether the packet matches the context.

At 806, the match logic determines a context index value for the packet based on a second subset of bits extracted from the header using an offset value. The scalable packet processor may extract the second subset of bits or bit field from the header using another offset value and/or a field-width value to obtain the second subset of bits. In some cases, a third subset of bits are obtained from the header of the packet and a Boolean operation (e.g., XOR) is implemented with the second and third subsets of bits. Further, the result of the Boolean operation may be combined with another index offset value to determine the context index value for the packet.

At 808, a context generator of the scalable packet processor obtains a context base value and context range value from a lookup table based on an identifier of the virtual function. For example, the scalable packet processor may use a VF number to access a row of the lookup table to obtain the context base value and the context range value. In some cases, the lookup table stores pairs of context base and range values that correspond to different instances of match logic of the scalable packet processor.

At 810, the context generator generates a context identifier using the context index value, context base value, and context range value. In aspects, the context generator applies modular arithmetic to the index value, context base value, and context range value to generate the context identifier or context label. By so doing, the described aspects for implementing a lookup table with modular arithmetic can optimize storage space reserved for context identifiers by not storing each and every discrete context value in the lookup table.

At 812, the scalable packet processor associates the context identifier with the packet, which may enable a bus or component to distribute the packet to resources of the context based on the context identifier. At 814, the scalable packet processor sends the packet and context identifier to an entity for distribution to resources of the context. For example, a host bus and/or memory controller may send the packet to a queue in a memory with which the context is associated based on the context identifier. A CPU core, application, or VM of the context may then access the data of the packet from the memory queue for further processing.

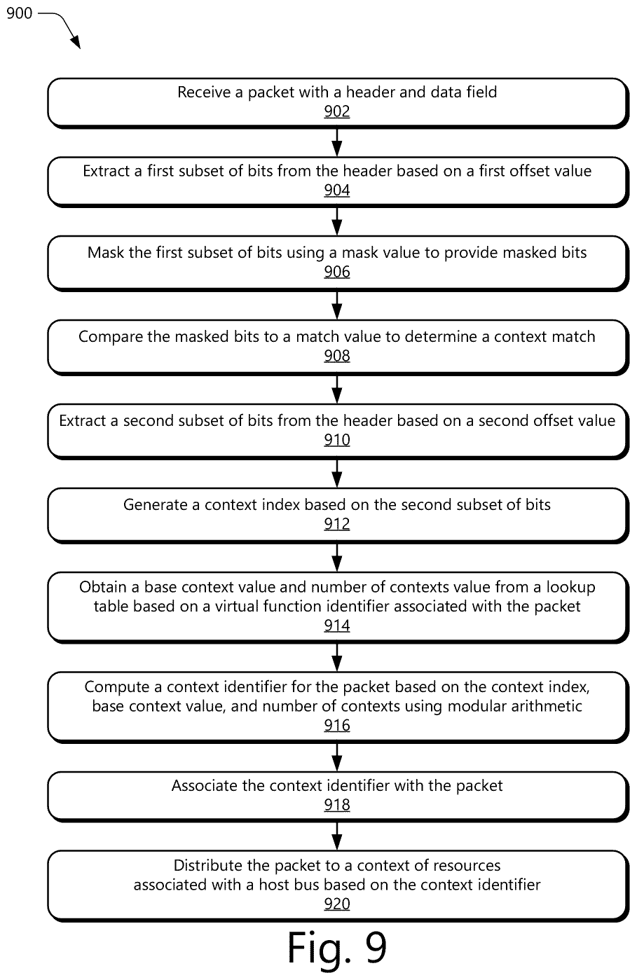

FIG. 9 depicts an example method 900 for processing packets for distribution to resources of a context in accordance with one or more aspects. The operations of the method 900 may be implemented by a scalable packet processor 132, match logic 144, and/or context generator 146.

At 902, match logic of a scalable packet processor receives a packet with a header and data field. The packet may be formatted in compliance with any suitable packet format, such that the header of the packet is structured with predefined bit fields. In some cases, the packet is received via a data network or fabric to which a host bus adapter is operably coupled. At 904, the match logic of the scalable packet processor extracts a first subset of bits from the header based on a first offset value. For example, the match logic may extract the first subset of bits or bit field from the header based on an offset value programmed into an offset CSR of the match logic.

At 906, the match logic of the scalable packet processor masks the first subset of bits using a mask value to provide masked bits. The match logic may mask the first subset of bits using a mask value programmed into a mask CSR of the match logic. At 908, the match logic of the scalable packet processor compares the masked bits to a match value to determine a context match. Alternatively or additionally, the match logic may compare a type of the packet to a type value stored in another CSR of the match logic to determine that the packet matches the context that the match logic is configured to match.

At 910, the match logic of the scalable packet processor extracts a second subset of bits from the header based on a second offset value. The match logic may extract the second subset of bits or bit field from the header based on offset and field-width values programmed to an index offset CSR of the match logic. At 912, the match logic of the scalable packet processor generates a context index based on the second subset of bits. In some cases, the match logic implements a Boolean operation with a third subset of bits extracted from the header and/or combines the second subset of bits with another offset value of a corresponding offset CSR of the match logic. The match logic can then provide the indication of the packet match and the index value to a context generator of the scalable packet processor.

At 914, the context generator of the scalable packet processor obtains a base context value and number of contexts value from a lookup table based on a virtual function identifier associated with the packet. In some cases, the context generator accesses a row of the lookup table based on a VF identifier of the packet to obtain the context base value and the context range value. In some cases, the lookup table stores pairs of context base and range values that correspond to different instances of match logic of the scalable packet processor.

At 916, the context generator of the scalable packet processor computes a context identifier for the packet based on the context index, base context value, and number of contexts using modular arithmetic. By so doing, the described aspects for implementing a lookup table with modular arithmetic can optimize storage space reserved for context identifiers by not storing each and every discrete context value in the lookup table. At 918, the scalable packet processor associates the context identifier with the packet and, at 920, the scalable packet processor distributes the packet to a context of resources associated with a host bus based on the context identifier.

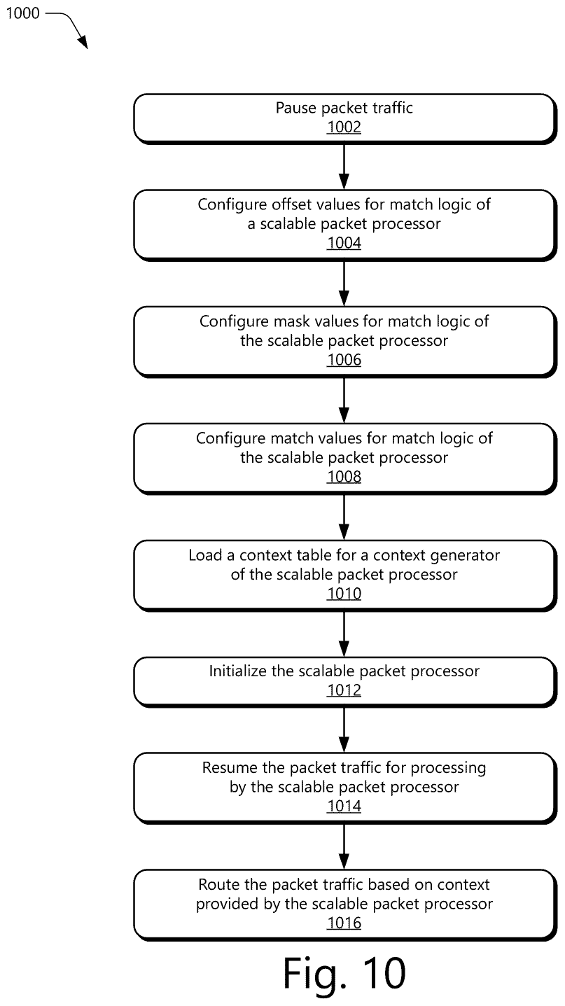

FIG. 10 depicts an example method 1000 for initializing a scalable packet processor in accordance with one or more aspects. The operations of the method 1000 may be implemented by or with a scalable packet processor 132, settings 140, match logic 144, and/or context generator 146.

At 1002, a scalable packet processor or host bus adapter pauses packet traffic. For example, the host bus adapter or scalable packet process may generate a signal that quiesces packet traffic on an interconnect, fabric, or bus. At 1004, firmware of the host bus adapter or a communication transceiver can configure offset values for match logic of the scalable packet processor. For example, the firmware can program, from settings, the offset values to one or more instances of match logic of the scalable packet processor.

At 1006, the firmware of the host bus adapter or communication transceiver may configure mask values for the match logic of the scalable packet processor. In some cases, the firmware programs, from settings, the mask values to the one or more instances of match logic of the scalable packet processor. At 1008, the firmware of the host bus adapter or communication transceiver configures match values for match logic of the scalable packet processor. Alternatively or additionally, the firmware or HBA controller can configure packet type values to the one or more instances of the match logic. Thus, the firmware or other controller of the host bus adapter can program the CSRs of the match logic with the corresponding offset, mask, type, and match values to enable operation of the match logic of the scalable packet processor.

At 1010, firmware of the host bus adapter or communication transceiver loads a context table for a context generator of the scalable packet processor. The context table may include a table of context base value and context range pairs, such as context table 312 as described herein. At 1012 firmware of the host bus adapter or a communication transceiver initializes the scalable packet processor, which may include enabling the match logic and/or VF related control signaling for logic and encoding circuitry of the scalable packet processor. At 1014, the firmware of the host bus adapter or communication transceiver resumes the packet traffic for processing by the scalable packet processor. This may include unpausing or restarting the packet traffic of a bus, fabric, or interconnect from which the scalable packet processor receives packets. At 1016, the host bus adapter or another entity routes the packet traffic based on context provided by the scalable packet processor.

### System-on-Chip

FIG. 11 illustrates an example System-on-Chip (SoC) 1100 environment in which various aspects of scalable packet processing may be implemented. The SoC 1100 may be implemented in any suitable system or device, such as a network switch device, host bus adapter, switch telemetry device, artificial intelligence accelerator, router, wireless access point, smart-phone, netbook, tablet computer, access point, network-attached storage, camera, smart appliance, printer, set-top box, server, data storage center, solid-state drive (SSD), hard disk drive (HDD), storage drive array, automotive computing system, or any other suitable type of device (e.g., others described herein). Although described with reference to a SoC, the entities of FIG. 11 may also be implemented as other types of integrated circuits or embedded systems, such as an application-specific integrated-circuit (ASIC), memory controller, storage controller, communication controller, application-specific standard product (ASSP), digital signal processor (DSP), programmable SoC (PSoC), system-in-package (SiP), or field-programmable gate array (FPGA).

The SoC 1100 may be integrated with electronic circuitry, a microprocessor, memory, input-output (I/O) control logic, communication interfaces, firmware, and/or software useful to provide functionalities of a network switch device, host bus adapter, computing device, host system, or storage system, such as any of the devices or components described herein (e.g., networking equipment or accelerator). The SoC 1100 may also include an integrated data bus, crossbar, or interconnect fabric (not shown) that couples the various components of the SoC for control signaling, data communication, and/or routing between the components. The integrated data bus, interconnect fabric, or other components of the SoC 1100 may be exposed or accessed through an external port, network data interface, parallel data interface, serial data interface, fabric-based interface, peripheral component interface, or any other suitable data interface. For example, the components of the SoC 1100 may access or control external data networks, storage media, or memory channels, through an external interface or off-chip data interface.

In this example, the SoC 1100 includes various components such as input-output (I/O) control logic 1102 and a hardware-based processor 1104 (processor 1104), such as a microprocessor, processor core, application processor, DSP, or the like. The SoC 1100 also includes memory 1106, which may include any type and/or combination of RAM, SRAM, DRAM, non-volatile memory, ROM, one-time programmable (OTP) memory, multiple-time programmable (MTP) memory, Flash memory, and/or other suitable electronic data storage. In some aspects, the processor 1104 and firmware 1108 stored on the memory 1106 are implemented as a host bus adapter or packet switch to implement functionalities of packet switching, routing, or distribution as described herein. In the context of this disclosure, the memory 1106 can store data, code, instructions, firmware 1108, or other information of the SoC 1100 via non-transitory signals, and does not include carrier waves or transitory signals. Alternately or additionally, SoC 1100 may comprise a data interface (not shown) for accessing additional or expandable off-chip storage media, such as solid-state memory (e.g., Flash or NAND memory), magnetic-based memory media, or optical-based memory media.

The SoC 1100 can include any suitable combination of firmware 1108, applications, programs, software, and/or operating system, which may be embodied as processor-executable instructions maintained on the memory 1106 for execution by the processor 1104 to implement functionalities of the SoC 1100. The SoC 1100 may also include other communication interfaces, such as a transceiver interface for controlling or communicating with components of a local on-chip (not shown) or off-chip communication transceiver. Alternately or additionally, the transceiver interface may also include or implement a signal interface to communicate radio frequency (RF), intermediate frequency (IF), or baseband frequency signals off-chip to facilitate wired or wireless communication through transceivers, or physical layer transceivers (PHYs) coupled to the SoC 1100. For example, the SoC 1100 may include one or more transceiver interfaces configured to enable communication over a wired or wireless network, such as to enable the SoC to operate as a controller of a network switch device or other packet routing apparatus.

In this example, the SoC 1100 also includes instances of a network interface 126, host bus interface 128, settings 140, and packet buffer 142, which may be implemented as described herein. The SoC 1100 also includes a scalable packet processor 132 that includes match logic 144, context generator 146, and a context table 312 for implementing aspect of scalable packet processing. In accordance with various aspects, the packet match logic 144 can parse and compare portions of packet headers with match values to determine matches for packets of a context. The match logic may also parse the headers of the packets and manipulate bits of the parsed headers through Boolean operations to generate an index value useful to a generate context identifier for the packet matching the context. Based on an indication of a packet match, the context generator 146 (or generation logic) can access a lookup table of context base and context range value pairs based on a virtual function to which the packet is associated. By including these value pairs, the lookup table may be implemented in less memory area than other types of context routing tables, which include explicit or discrete values for every available context of a system. Based on the index value, a context base value, and a context range value, the context generator 146 computes a context identifier for the packet through modular arithmetic, which can be associated with the packet and sent with the packet to enable routing of the packet to resources (e.g., a memory queue) of the context. By so doing, the scalable packet processor may route packets of different protocols to respective resources of contexts with reduced hardware cost and less silicon area. Any of these entities may be embodied as disparate or combined components, as described with reference to various aspects presented herein. Examples of these components and/or entities, or corresponding functionality, are described with reference to the respective components or entities of the operating environment 100 of FIG. 1 or respective configurations illustrated in FIGS. 2-7, the methods depicted in FIGS. 8-10, and/or throughout this disclosure.

The scalable packet processor 132, either in whole or in part, may be implemented as hardware and/or processor-executable instructions (e.g., firmware 1108, settings 140, or microcode) maintained by the memory 1106 and executed by the processor 1104 to implement various aspects and/or features of scalable packet processing. The scalable packet processor 132, match logic 144, and context generator 146 may be implemented independently or in combination with any suitable component or circuitry to implement aspects described herein. For example, the scalable packet processor 132 may be implemented as part of a DSP, host bus adapter, processor/storage bridge, I/O bridge, graphics processing unit, memory controller, network controller, storage controller, arithmetic logic unit (ALU), or the like. The scalable packet processor 132 may also be provided integral with other entities of SoC 1100, such as integrated with the processor 1104, memory 1106, network interfaces, or firmware 1108 of the SoC 1100. Alternately or additionally, the scalable packet processor 132, match logic 144, context generator 146, and/or other components of the SoC 1100 may be implemented as hardware, firmware, fixed logic circuitry, or any combination thereof.

Although the subject matter of a scalable packet processor has been described in language specific to structural features and/or methodological operations, it is to be understood that the subject matter recited in the appended claims is not necessarily limited to the specific examples, features, configurations, or operations described herein, including orders in which they are performed.

What is claimed is:

1. A method for processing packets for distribution over a host bus, comprising:
receiving, from an interconnect, a packet comprising a header and a data field, the packet associated with a virtual function;
determining that the packet matches a packet format of a context by comparing a first subset of bits of the header to a format match value;
determining a context index value based on a second subset of bits extracted from the header;
obtaining a context base value and a context range value from a lookup table based on an identifier of the virtual function;
generating a context identifier using the context index value, the context base value, and the context range value;
associating the context identifier with the packet; and
sending the packet with the context identifier over the host bus for distribution to resources of the context.

2. The method as recited in claim 1, wherein:
the context identifier for the packet is generated by applying a modular arithmetic function to the context index value, the context base value, and the context range value; and
the lookup table does not include discrete context identifier values.

3. The method as recited in claim 1, wherein:
the lookup table comprises multiple pairs of context base values and context range values associated with the virtual function;
the context base value and the context range value are a first pair of context base values and context range values associated with the virtual function;
the determination that the packet matches the packet format of the context is performed by a first instance of multiple instances of packet match logic; and
the method further comprises selecting the first pair of context base values and context range values based on the match being determined by the first instance of packet match logic.

4. The method as recited in claim 1, further comprising:
extracting the first subset of bits from the header of the packet based on a first offset value; or
extracting the second subset of bits from the header of the packet based on a second offset value.

5. The method as recited in claim 4, wherein the format match value is a first format match value and the method further comprises:
extracting a third subset of bits from the header of the packet based on a third offset value; and
determining that the packet matches the packet format of the context by comparing the first subset of bits of the header to the first format match value and comparing the third subset of bits of the header to the second format match value.

6. The method as recited in claim 5, further comprising determining that the packet matches the packet format of the context by comparing a type of the packet with a packet type value.

7. The method as recited in claim 4, further comprising:
applying a bit mask to the first subset of bits to provide a subset of masked bits of the header; and
determining that the packet matches the packet format of the context by comparing the subset of masked bits of the header to the format match value.

8. The method as recited in claim 4, further comprising extracting the second subset of bits from the header of the packet based on the second offset value and a field-width value.

9. The method as recited in claim 8, wherein the field-width value is a first field-width value, and the method further comprises:
extracting a third subset of bits from the header of the packet based on a third offset value and a second field-width value; and
determining the context index value of the packet based on the second subset of bits and the third subset of bits extracted from the header.

10. The method as recited in claim 1, wherein the header of the packet is formatted in compliance with a protocol that includes one of Fibre Channel, Ethernet, peripheral component interconnect express (PCI Express), compute express link (CXL), InfiniBand, or a custom protocol.

11. An integrated circuit comprising:
packet match logic comprising:
a register configured to receive a header of a packet;
a first configurable register to store a first offset value by which a first subset of bits is extracted from the header of the packet;
a second configurable register to store a match value;
a comparator configured to generate a match indicator in response to the first subset of bits extracted from the header matching the match value;
a third configurable register to store a second offset value by which a second subset of bits are extracted from the header of the packet; and
index generation logic configured to generate a context index value based on the second subset of bits of the header of the packet; and
context generation logic comprising:
an encoder with inputs operably coupled with an output of the comparator of the packet match logic and an output of at least one other instance of packet match logic;
a multiplexor having an input coupled to an output of the index generation logic and configured to select the index value based on an output of the encoder;
a context table configured to store, in association with virtual functions, respective pairs of base context values and context range values; and
a modular arithmetic circuit configured to:
obtain, based on a virtual function identifier associated with the packet and from a lookup table, the respective pair of the base context value and the context range value that corresponds to the virtual function of the packet; and
generate a context identifier for the packet based on the context index value, the base context value, and the context range value.

12. The integrated circuit as recited in claim 11, wherein:
the modular arithmetic circuit is further configured to generate the context identifier for the packet by applying a modular arithmetic function to the context index value, the context base value, and the context range value; and
the lookup table does not include discrete context identifier values, context labels, or resource addresses.

13. The integrated circuit as recited in claim 11, wherein the context generation logic is configured to:
associate the context identifier with the packet; and
send the packet with the context identifier over a host bus for routing to resources of the context based on the context identifier.

14. The integrated circuit as recited in claim 11, wherein the match value is a first match value, the comparator is a first comparator configured to provide the match indicator as a first match indicator, and the integrated circuit further comprises:
a fourth configurable register to store a third offset value by which a third subset of bits is extracted from the header of the packet;
a fifth configurable register to store a second match value;
a second comparator configured to generate a second match indicator in response to the third subset of bits extracted from the header matching the second match value; and
a logic circuit configured to generate a packet match indication based on the first match indicator and the second match indicator.

15. The integrated circuit as recited in claim 11, wherein the match value is a first match value, the comparator is a first comparator configured to provide the match indicator as a first match indicator, and the integrated circuit further comprises:
a fourth configurable register to store a packet type value;
a second comparator configured to generate a second match indicator in response to a type of the packet matching the packet type value; and
a logic circuit configured to generate a packet match indication based on the first match indicator and the second match indicator.

16. A system-on-chip (SoC) comprising:
a first interface to an interconnect;
a second interface to a host bus;
packet match logic configured to:
receive, from the first interface, a packet comprising a header and a data field, the packet associated with a virtual function;
determine that the packet matches a packet format of a context by comparing a first subset of bits of the header to a format match value;
determine a context index value based on a second subset of bits extracted from the header; and
context generation logic configured to:
obtain a context base value and a context range value from a lookup table based on an identifier of the virtual function;
generate a context identifier using the context index value, the context base value, and the context range value;
associate the context identifier with the packet; and
send, via the second interface, the packet with the context identifier for distribution to resources of the context coupled to the host bus.

17. The SoC as recited in claim 16, wherein:
the context generation logic is configured to implement modular arithmetic to generate the context identifier based on the context index value, the context base value, and the context range value; and
the lookup table does not include discrete context identifier values, discrete context labels, or discrete context tags.

18. The SoC as recited in claim 16, wherein the format match value is a first format match value and the packet match logic is further configured to:
extract the first subset of bits from the header of the packet based on a first offset value;
extract a third subset of bits from the header of the packet based on a second offset value; and
determine that the packet matches the packet format of the context by comparing the first subset of bits of the header to the first format match value and comparing the third subset of bits of the header to the second format match value.

19. The SoC as recited in claim 16, wherein the packet match logic is further configured to determine that the packet matches the packet format of the context by comparing a type of the packet with a packet type value.

20. The SoC as recited in claim 16, wherein the SoC is configured as a host bus adapter, a communication transceiver, a memory controller, a storage controller, a network switch device, a switch telemetry device, an artificial intelligence accelerator, or an accelerator SoC.
